(19) United States
(12) Patent Application Publication
(10) Pub. No.: US 2011/0273472 A1
(43) Pub. Date: Nov. 10, 2011

(54) Dose Volume Histogram Evaluator

(76) Inventor: Jimm Grimm, Huntington Valley, PA (US)

(21) Appl. No.: 12/983,434

(22) Filed: Jan. 3, 2011

Related U.S. Application Data
(60) Provisional application No. 61/335,351, filed on Jan. 6, 2010.
(60) Provisional application No. 61/335,371, filed on Jan. 6, 2010.

(51) Int. Cl. G09G 5/00; G06T 11/20

(52) U.S. Cl. 345/629; 345/440

(57) ABSTRACT

A software device that aids the user to evaluate the dose distribution for radiation therapy treatment plans. Radiation therapy treats a desired tumor volume as well as undesired volumes of critical anatomical structures within the patient. The dose volume histogram (DVH) is commonly used to assess the volume of tumor and the volumes of critical structures receiving certain doses. The disclosed invention overlays dose tolerance limits onto the DVH to conveniently and comprehensively enable the user to evaluate the quality of the radiation treatment plan.

References Cited

| | | |
|---|---|---|
| 3871579 | Mar. 18, 1975 | Inamura |
| 3987281 | Oct. 19, 1976 | Hodes |
| 4845370 | July 4, 1989 | Thompson, et al. |
| 5012357 | Apr. 30, 1991 | Schoeppel, et al. |
| 5205289 | Apr. 27, 1993 | Hardy, et al. |
| 5339812 | Aug. 23, 1994 | Hardy, et al. |
| 5647663 | Jul. 15, 1997 | Holmes |
| 6167294 | Dec. 26, 2000 | Busch |
| 6222544 | Apr. 24, 2001 | Tarr, et al. |
| 6393096 | May 21, 2002 | Carol, et al. |
| 6741674 | May 25, 2004 | Lee |
| 7027557 | Apr. 11, 2006 | Llacer |
| 7186991 | Mar. 6, 2007 | Kato, et al. |
| 7362848 | Apr. 22, 2008 | Saracen, et al. |
| 7593505 | Sep. 22, 2009 | Saracen, et al. |

Shipley WU, Tepper JE, Prout GR, Verhey U, Mendiondo OA, Goitein M, Koehler AM, Suit HD. Proton radiation as boost therapy for localized prostatic carcinoma. J. Am. Med. Assoc. 1979 May; 241(18):1912-5.

Austin-Seymour MM, Chen GT, Castro JR, Saunders WM, Pitluck S, Woodruff KH, Kessler M. Dose volume histogram analysis of liver radiation tolerance. Int J Radiat Oncol Biol Phys. 1986 Jan; 12(1):31-5.

Mohan R, Brewster LJ, Barest GD. A technique for computing dose volume histograms for structure

### CROSS-REFERENCE TO RELATED APPLICATIONS

This application claims the benefit of provisional patent application Ser. No. 61/335,351, filed 1/6/2010 by Jimm Grimm

This application is related to provisional patent application Ser. No. 61/335,371, filed 1/6/2010 by Jimm Grimm.

### SEQUENCE LISTING OR PROGRAM

Program flowchart in FIG. 7. combinations. Med. Phys. 14, 1048 (1987 Nov).

Emami B, Lyman J, Brown A, Coia L, Goitein M, Munzenrider JE, Shank B, Solin LJ, Wesson M. Tolerance of normal tissue to therapeutic radiation. Int J Radiat Oncol Biol Phys. 1991:21;109-122.

Lax I. Target dose versus extratarget dose in stereotactic radiosurgery. Acta Oncol. 1993;32(4):453-7.

Lax I, Blomgren H, Näslund I, Svanstrom R. Stereotactic radiotherapy of malignancies in the abdomen. Methodological aspects. Acta Oncol. 1994;33(6):677-83.

Murphy MJ, Cox RS. The accuracy of dose localization for an image-guided frameless radiosurgery system. Med. Phys. 1996;23(12):2043-2049.

Wulf J, Hadinger U, Oppitz U, Thiele W, Ness -Dourdoumas R, Flentje M. Stereotactic radiotherapy of targets in the lung and liver. Strahlenther Onkol 2001;177:645 55.

Chang BK, Timmerman RD. Stereotactic Body Radiation Therapy: A Comprehensive Review. J Clin Oncol 2007;30:637-644.

### FIELD OF THE INVENTION

The invention relates to the field of radiation therapy treatment planning.

BACKGROUND AND SUMMARY OF THE INVENTION

For most treatment modalities in radiation oncology, a 3D image of the patient's internal anatomy is usually obtained using CT scan, MR scan, ultrasound, PET scan or other imaging techniques. A physician, physicist, or dosimetrist then contours (i.e. draws) outlines of patient anatomy in a treatment planning system. All relevant anatomical structures are contoured; including tumor targets as well as critical organs. The treatment planning system is then used to determine the expected radiation dose distribution throughout the 3D image representation of the patient. From this overall 3D dose distribution, the treatment planning system computes the dose to all the contoured anatomical structures. In the prior art, the dose to all contoured anatomical structures is summarized in the form of a Dose Volume Histogram (DVH), which is a plot of volume versus dose, or alternatively, a plot of dose versus volume. The embodiment disclosed in this description is of the first form, but it also applies to the dose versus volume form, just by exchanging the x and y axes.

One slice of a CT scan is shown in FIG. 1 with dose lines overlaid. The entire CT scan consists of numerous such 2D slices, comprising the entire 3D volume of the target area within the patient. The treatment planning system determines how many points in each contoured anatomical structure receive each particular dose value, and it organizes this information into a DVH, as shown in FIG. 2.

As the prior art abundantly shows, dose tolerance limits and computerized treatment planning systems that calculate DVHs have been in existence for more than twenty five years. However, until the presently disclosed invention there is still no treatment planning system that overlays the dose tolerance limits onto the DVH and warns the user if any limits have been exceeded. The conventional radiation dose tolerance limits (Emami et al 1991) relate to a large volume of the contoured anatomical structure, such as 1/3 of the total volume, 2/3 of the total volume, or the dose to the entire volume. These large volumes can visually be seen on the DVH, so although it would be more convenient and comprehensive to use a system like the present invention, clinical practitioners have become accustomed to doing this manually for the past twenty five years.

The stereotactic body radiation therapy (SBRT) dose tolerance limits (Wulf et al 2001, Chang & Timmerman 2007) are dramatically different, however. Whereas in conventional radiation therapy treatments the goal is to deliver a uniform dose over a fairly large target, the goal of SBRT is to deliver a much higher dose per treatment to a small, focal, precisely defined target (Lax 1993, Lax et al 1994, Murphy & Cox 1996) with much steeper dose gradients. The SBRT dose tolerance limits are typically for a much smaller volume, like five cubic centimeters (5 cc), or 1 cc, or even the maximum point dose. These very small volumes of dose are not as easily visualized on the DVH making the presently disclosed invention much more important for patient safety—yet still this has been performed manually in all clinics that have treated with SBRT for the past fifteen years, probably due to clinical habits from conventional radiation therapy.

An example DVH of volume versus dose is shown in FIG. 2 for an SBRT treatment near a patient's small bowel. The disclosed invention works equally well for any contoured anatomical targets or critical structures; small bowel is just presented as an example to facilitate explanation. The disclosed invention overlays dose limits onto the DVH, as shown in FIG. 3 for the example in FIG. 2. The quality of the treatment plan in FIG. 2 is very subjective because there is no concise information to indicate whether the plan is good or not. However, it is much more useful to display the plan as in FIG. 3, where it becomes clear that a certain volume of small bowel exceeds a preset dose limit

In FIGS. 4 and 5 another example is shown, in which case multiple limits are overlaid on a single DVH plot. In FIG. 5 it may be clearly seen that the example esophagus dose from the SBRT treatment is below two of the limits but above the third limit, whereas the prior art FIG. 4 is more hazardous to patients because no dose limits are explicitly shown. Cursory manual inspection of the DVH in FIG. 4 looks fairly good, but the present invention clearly shows in FIG. 5 that the esophagus dose exceeds the maximum point dose limit by 10.8 Gray. Although only a very small volume, 0.24 cc of esophagus exceeds the limit, it is such a high dose that the patient could be at increased risk of esophageal fistula. This invention has the potential to improve patient safety by clearly warning clinical practitioners whenever the dose to contoured anatomical structures is too high, thereby showing which parts of the treatment plan need to be improved.

### BRIEF DESCRIPTION OF THE DRAWINGS

FIG. 1 is one slice of a treatment plan for a patient with dose lines overlaid on the CT scan.

FIG. 2 is a prior art Dose Volume Histogram.

FIG. 3 is the disclosed invention: prior art Dose Volume Histogram with dose limit overlaid.

FIG. 4 is another prior art Dose Volume Histogram.

FIG. 5 is the disclosed invention: prior art Dose Volume Histogram with multiple dose limits overlaid.

FIG. 6 is the disclosed invention: idealized Dose Volume Histogram with multiple dose limits overlaid.

FIG. 7 is a flowchart of the disclosed invention.

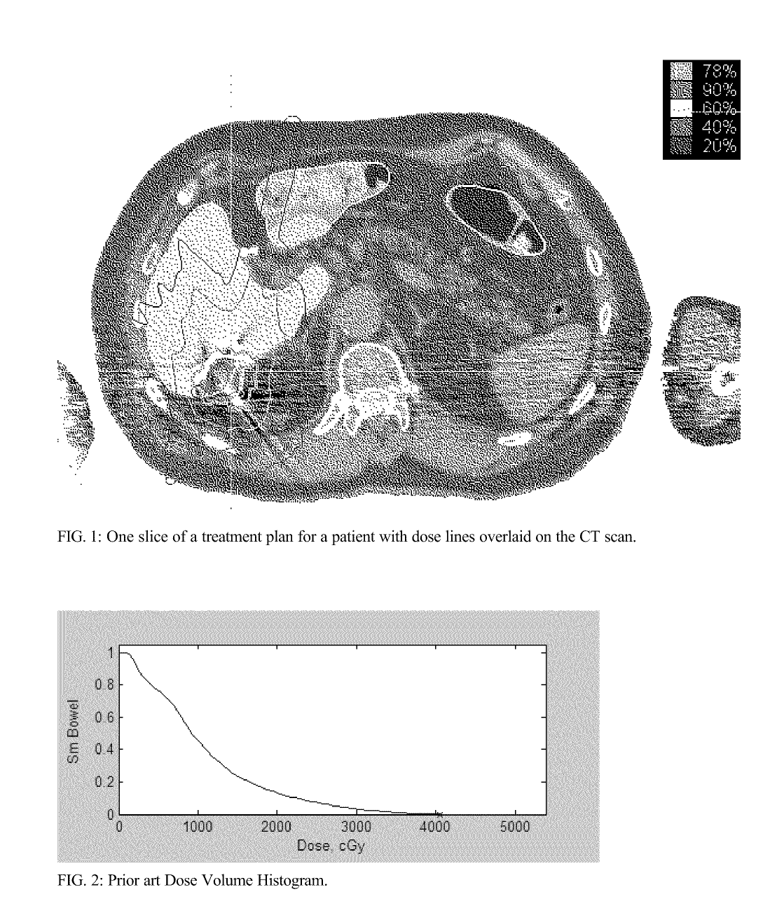

### DETAILED DESCRIPTION OF THE INVENTION

A DVH can be expressed as a plot of \vec{x}, \vec{y}, where \vec{x} is a vector of the range of doses in the plan, from the minimum dose to the maximum dose, and \vec{y} is the corresponding vector of the volumes of the anatomical structure receiving each particular dose. The dose \vec{x} and the volume \vec{y} may be expressed in any applicable units, either absolute units or in normalized relative units.

Dose tolerance limits may be expressed in three different formats:

A) Only volume Y_{A} of a specified structure may exceed dose X_{A}.

B) Only Y_{B} percent of a specified structure may exceed dose X_{B}.

C) Only volume Y_{c}=0 (zero) of a specified structure may exceed dose X_{c}.

Limit format C specifies that the maximum dose of the specified structure may not exceed dose X_{c}. All three limits may be expressed in the format:

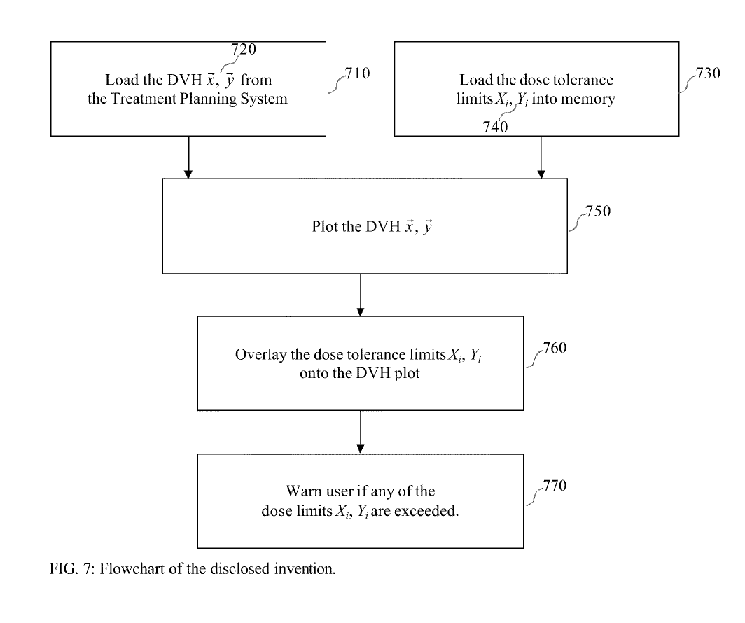

Only Yᵢ of a specified structure may exceed dose Xᵢ, where i is chosen from the set {A, B, C}, and the units of Yᵢ are volume or percent, and the units of Xᵢ is dose. Using this notation, the disclosed invention may be described by the flowchart in FIG. 7.

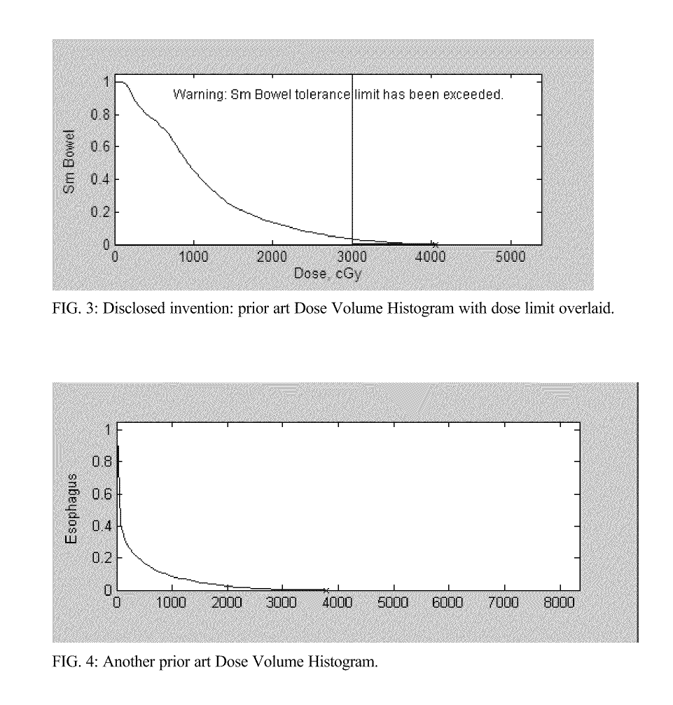

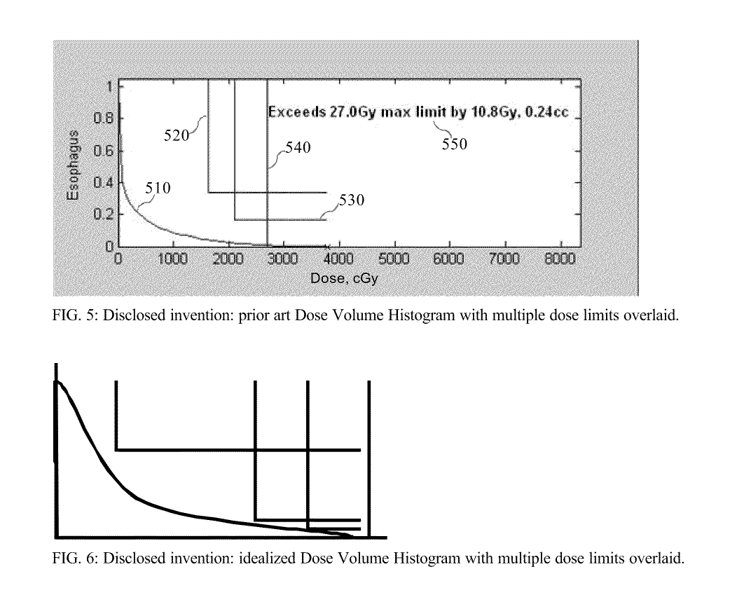

The points Xᵢ, Yᵢ could be displayed as a cross, plus, dot, or asterisk, or plotted in any manner that clearly visible and understandable to the user. We have found it convenient to plot the points as an “L” shape, where the corner of the “L” is plotted at the point Xᵢ, Yᵢ, and the tails upward and to the right emphasize the relative level of the dose tolerance limit to the DVH, as seen in FIG. 3 and FIG. 5. We stress, however, that this is simply one of many embodiments; the invention includes all manner of displaying the points Xᵢ, Yᵢ.

A flowchart of the disclosed invention is in FIG. 7. The user can export the DVH data 720 from the treatment planning system into a computer file, or the treatment planning system could call the presently disclosed invention as a function call. In either case, the first import module 710 imports the DVH data 720. The user can store the dose tolerance limits 740 in a computer file, or another program could enable the user to specify the dose tolerance limits 740 and call the disclosed invention as a function call. In either case, the second import module 730 loads the dose tolerance limits 740. Module 750 plots the DVH data 720. Module 760 then overlays the dose tolerance limits 740 onto the same plot. Finally, if any dose tolerance limits 740 have been exceeded, module 770 warns the user.

The warning to the user could be provided in many ways: a textual message could be displayed, or the DVH or dose tolerance limit could be changed to a certain color, or an asterisk or other marker could be displayed, the background color could change, and audible sound could be used, or various other means could be employed to warn the user.

An example is shown in FIG. 5. The plot of the DVH data 720 is curve 510. In this example, three dose tolerance limits 740 have been specified by the user, and they are curves 520, 530, and 540. The DVH is below two of the three dose tolerance limits since curves 520 and 530 do not cross the DVH curve 510. However, the third dose tolerance limit, represented by curve 540, does cross the DVH curve 510, so this dose tolerance limit has been exceeded by the DVH data 720. Therefore, the warning message 550 has been displayed to warn the user of the excessive dose.

While the invention has been described in connection with what is presently considered to be the most practical and preferred embodiment, it is to be understood that the invention is not to be Limited to the disclosed embodiment, but on the contrary, is intended to cover various modifications and equivalent arrangements included within the spirit and scope of the appended claims.

What is claimed is :

1. A method in a computer that plots the DVH from a radiation therapy treatment planning system graphically,

2. The method of claim 1, wherein dose tolerance limits for contoured anatomical structures as specified by the user are overlaid onto the DVH plots,

3. The method of claims 1 and 2, wherein the user is warned if the DVH to any of the contoured anatomical structures exceeds any of the user-specified dose tolerance limits
